(19) United States
(12) Patent Application Publication
(10) Pub. No.: US 2006/0129866 A1
(43) Pub. Date: Jun. 15, 2006

(54) Test validation of an integrated device

(76) Inventors: James E. Chandler, Mission Viejo, CA (US); John F. Zumkehr, Orange, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/348,831

(22) Filed: Feb. 6, 2006

Related U.S. Application Data
(62) Division of application No. 10/294,183, filed on Nov. 13, 2002.

(51) Int. Cl. G06F 1/12

(52) U.S. Cl. 713/401

(57) ABSTRACT

Embodiments of a method and/or an apparatus to test a delay lock loop circuit, chipset, or memory controller or memory controller hub (MCH) are described.

### CROSS-REFERENCES TO RELATED APPLICATIONS

This U.S. patent application is a division of U.S. Patent application Ser. No. 10/294,183 filed Nov. 13, 2002.

### BACKGROUND OF THE INVENTION

1. Field of the Invention

The present invention relates to test validation of an integrated device, such as, a chipset, or a DLL, or a memory controller, or a memory controller hub (MCH).

2. Background Information

A Dynamic Random Access Memory, DRAM, is a typical memory to store information for computers and computing systems, such as, personal digital assistants and cellular phones. DRAMs contain a memory cell array having a plurality of individual memory cells; each memory cell is coupled to one of a plurality of sense amplifiers, bit lines, and word lines. The memory cell array is arranged as a matrix of rows and columns, and the matrix is further subdivided into a number of banks.

One type of DRAM is a synchronous dynamic random access memory (SDRAM) that may allow for synchronous operation with a processor. Specific types of SDRAM are a single data rate (SDR) SDRAM and a double data rate (DDR) SDRAM. Typically, a DDR DRAM may send data (DQ), when enabled by a DQS clock signal, to a memory controller or memory controller hub (MCH). The memory controller or MCH may receive the data from the DDR DRAM by utilizing precision delay cells to provide a delayed DQS clock signal.

Typically, test equipment may have a skew, which is a timing specification that defines a range of time for a particular signal to be active, such as, a DQS signal, and is included as a guard-band during testing. However, the setup and hold times for the MCH and memory controller are more stringent than necessary to account for the tester guard-band. Setup and hold times are timing specifications that define when an integrated device may receive input data and the duration that the input data needs to be valid, respectively. Therefore, this causes inaccurate testing, such as, a test rejection of a properly functioning MCH or memory controller because of the stringent setup and hold times that are needed for the tester guard-band because of the skew.

### BRIEF DESCRIPTION OF THE SEVERAL VIEWS OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is a schematic diagram illustrating an embodiment of a test validation circuit in accordance with the claimed subject matter.

FIG. 2 is a flowchart illustrating an embodiment of a method in accordance with the claimed subject matter.

### DETAILED DESCRIPTION OF THE INVENTION

An apparatus and method for test validation of the following: a chipset, a Delay Lock Loop (DLL), a memory controller, or a memory controller hub (MCH) are described. In the following description, for purposes of explanation, numerous details are set forth in order to provide a thorough understanding of the present invention. However, it will be apparent to one skilled in the art that these specific details are not required in order to practice the present invention.

An area of current technological development relates to test validation of integrated devices. As previously described, a tester guard-band includes the tester skew for testing a MCH or memory controller and results in inaccurate testing because the memory controller or MCH setup and hold times are more restrictive than necessary. Therefore, this sometimes causes a test rejection of a properly functioning MCH or memory controller because of the stringent setup and hold times that are needed for the tester guard-band because of the skew.

In contrast, a method and apparatus to detect errors in the memory controller, chipset, MCH, or DLL, and improves testing accuracy by reducing tester guard-band is needed. The claimed subject matter reduces the tester guard-band because it utilizes an analysis of the phase differences of outputs of delay lines of a DLL. For example, in one embodiment, the claimed subject matter is a built in self-test (BIST) that is incorporated within an integrated device for validating delay lines by comparing a phase difference of outputs of a plurality of delay lines based at least in part on a calibration of the delay lines. In another embodiment, the claimed subject matter utilizes the BIST to detect defects in the delay lines by reducing the need for expensive high pin-count testers. Thus, the claimed subject matter improves testing accuracy because the detection of an error is based at least in part on manufacturing or design defects from the circuit rather than stringent setup and hold times due to the tester guard-band because of the skew.

BIST is a test methodology wherein the integrated device includes test circuitry for performing a test operation. As is well known in the art, phase delay is defined as a time delay of part of a wave identifying the phase and is measured by a ratio of the total phase shift in cycles to the frequency in Hertz (Hz). See, for example IEEE technical dictionary, 6th edition, 766 (1999). Also, phase difference is defined as a difference in phase between two sinusoidal functions substantially having the same period. See, for example IEEE technical dictionary, 6th edition, 766 (1999).

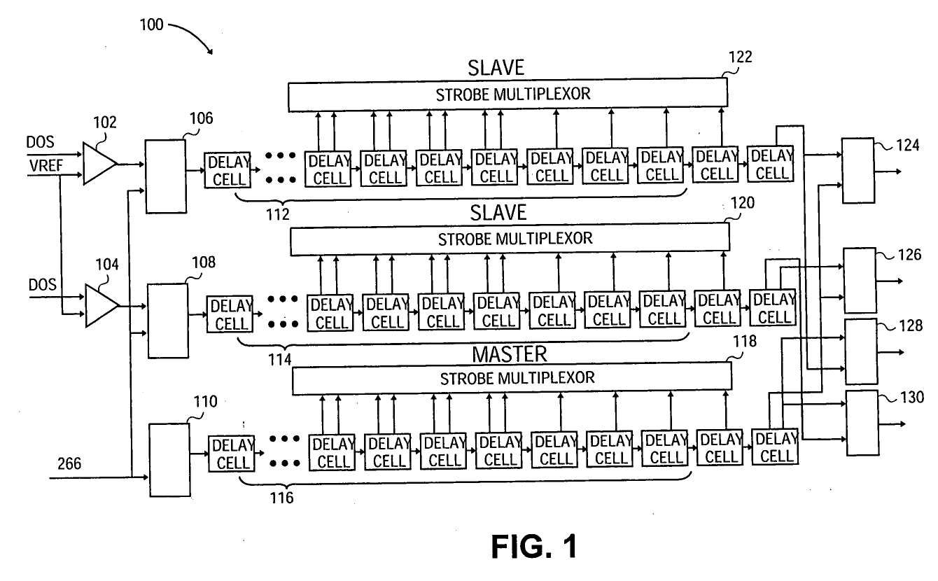

FIG. 1 is a schematic diagram illustrating an embodiment of a test validation circuit in accordance with the claimed subject matter. In one aspect, the schematic diagram incorporates a DLL and test circuitry to facilitates the testing of the DLL by detecting whether there is a phase difference between outputs of a plurality of delay lines. As previously described, phase delay is defined as a time delay of part of a wave identifying the phase and is measured by a ratio of the total phase shift in cycles to the frequency in Hertz (Hz). Likewise, phase difference is defined as a difference in phase between two sinusoidal functions substantially having the same period.

For example, in one embodiment, the plurality of delay lines receive a calibration clock signal that propagates through a plurality of individual delay cells. Subsequently, a plurality of phase detectors analyze whether there is any phase difference between the outputs of the plurality of delay lines. An error condition, for indicating the DLL circuit is functioning improperly, has occurred when the phase difference exceeds a predetermined threshold value. Otherwise, a pass condition has occurred for indicating the DLL circuit is functioning properly. The calibration and phase difference are discussed in further detail in the following paragraphs.

In one embodiment, the schematic 100 comprises, but is not limited to, a plurality of input ports 102 and 104, a plurality of multiplexers 106, 108, and 110, a plurality of delay lines 112, 114, and 116, a plurality of strobe multiplexers 118, 120, and 122, and a plurality of phase detectors 124, 126, 128, and 130.

In one embodiment, the schematic incorporates three delay lines 112, 114, and 116; also, each delay line comprises a plurality of individual delay cells. In contrast, in another embodiment, there are two delay lines. In one embodiment, the plurality of individual cells is programmable.

As previously described, the schematic diagram facilitates the testing of a DLL by detecting whether there is a phase difference between the outputs of the plurality of delay lines. Initially, at least one delay line is calibrated. For example, for the embodiment of three delay lines, the delay line 116 is designated as a master delay line and is calibrated to a desired delay, while the other two delay lines 112 and 114 are designated as slave lines. However, the claimed subject matter is not limited to this designation of slave and master delay lines. For example, the master delay line may be designated as 112 and the slave delay lines as 114 and 116, respectively.

The terminology of master and slave delay lines is merely intended to designate a reference for the comparison of the phase difference. For example, the master delay line functions as a reference, such as, for detecting a phase difference of the output of the slave delay line or lines with respect to the output of the master delay line which is accomplished by the phase detectors 124, 126, 128, and 130. The phase difference analysis is discussed in further detail in the following paragraphs.

In one embodiment, the calibration of the master delay line is accomplished by measuring the phase difference between a clock that propagates through the master delay line 116 to a clock that does not go through the master delay line 116. Subsequently, in one embodiment, the plurality of delay cells of all the delay lines may be set so that the clock's delay through the entire master delay line is equivalent to the clock's period.

In one embodiment, the slave delay lines 112 and 114 may utilize the same calibration clock that was utilized for calibrating the master delay line during a test mode of operation, such as, a BIST mode. Thus, in order to compare the delay between the slave delay lines and the master delay line, the same input to the master delay line that is used for calibration may be propagated to all slave delay lines. Therefore, for this embodiment, the reference calibration clock 266 may be applied to the plurality of multiplexers 106, 108, and 110. In one embodiment, the reference clock 266 may be a base memory clock of the DDR DRAM. Alternatively, the multiplexers 106 and 108 may select the DQS clock during a normal functional mode of operation. However, the claimed subject matter is not limited to a 266 Mhz DDR DRAM base clock. For example, other frequencies may be used, such as, a 333 Mhz clock or any multiple of the base clock may be used.

The master delay line 116 and the slave delay lines 112 and 114 outputs should be in the same phase because all the delay lines have an equivalent number of delay cells with equal delay values, if the delay lines are functioning properly. Thus, each delay cell may be calibrated or adjusted to insure a substantially consistent delay to account for any variations due to process, temperature, and voltage. For example, a control voltage is applied to all the delay cells in the delay lines. Thus, since the number of delay cells and control voltage are equivalent for all the delay lines, the overall delay of each delay line should be equivalent.

In one embodiment, the DLL is functioning properly when the outputs of master delay line and slave delay lines have equivalent phases, thus, no phase difference. In contrast, the DLL is functioning improperly when the phase difference between the output of the slave delay line or lines and the output of the master delay line exceeds a predetermined threshold value. One example of a predetermined threshold is the value of an individual delay cell. However, the claimed subject matter is not limited to this predetermined threshold value. For example, a variety of predetermined threshold values may be used, such as, a value of two delay cells or a fraction of a value of delay cell. Therefore, the claimed subject matter improves testing accuracy because the detection of a defect is based at least in part on one or more errors from the DLL lines rather than stringent setup and hold times due to the tester guard-band. Furthermore, the claimed subject matter incorporates test circuitry, such as, the schematic depicted in FIG. 1, to initiate a test during a BIST mode of operation for detecting errors in the delay lines without the need for expensive test equipment.

In one embodiment, the plurality of phase detectors 124, 126, 128, and 130 may detect the phase difference for the outputs of the master delay line and slave delay lines for both a rising and falling edge of an input test pulse. Phase detectors provide the capability to compare the phase of a clock signal with the phase of a reference clock signal. Such circuits are widely employed in conjunction with communication devices, integrated devices with phase-locked loops, and a variety of other communication systems. The claimed subject matter is, of course, not limited in scope to use with communication systems and many alternative applications may exist, such as, memory controllers, chipsets, and memory controller hubs (MCH).

In one embodiment, for example, the phase detector 124 compares the phase difference between slave line 112 and master line 116 for a first edge of the input test pulse; the phase detector 126 compares the phase difference between slave line 114 and master line 116 for a first edge of the input test pulse; the phase detector 128 compares the phase difference between slave line 112 and master line 116 for a second edge of the input test pulse; the phase detector 130 compares the phase difference between slave line 114 and master line 116 for a second edge of the input test pulse. In one embodiment, the first edge may be either a rising or falling edge and the second edge may be either a falling or rising edge of the input test pulse. However, the claimed subject matter is not limited to this embodiment. For example, in another embodiment, two phase detectors may be utilized to detect phase difference between a single slave delay line and a master delay line for a rising and falling edge of the input test pulse. Alternatively, in another embodiment, two phase detectors may be utilized to detect phase difference between two slave delay lines and a master delay line for either a rising or falling edge of the input test pulse. In yet another embodiment, six phase detectors may be utilized to detect phase difference between three slave delay lines and a master delay line for a rising and falling edge of the input test pulse.

In one embodiment, the plurality of strobe multiplexers 118, 120, and 122 allow for a “tap” off from the respective delay line resulting in different delays during a normal mode of operation. Thus, the strobe mulitiplexers allows access to an individual portion of the delay line. However, in another embodiment, the schematic does not include the plurality of strobe multiplexers 118, 120, and 122.

In one embodiment, the schematic is incorporated in a chipset. In another embodiment, the schematic is incorporated in a memory controller hub (MCH) or a memory controller.

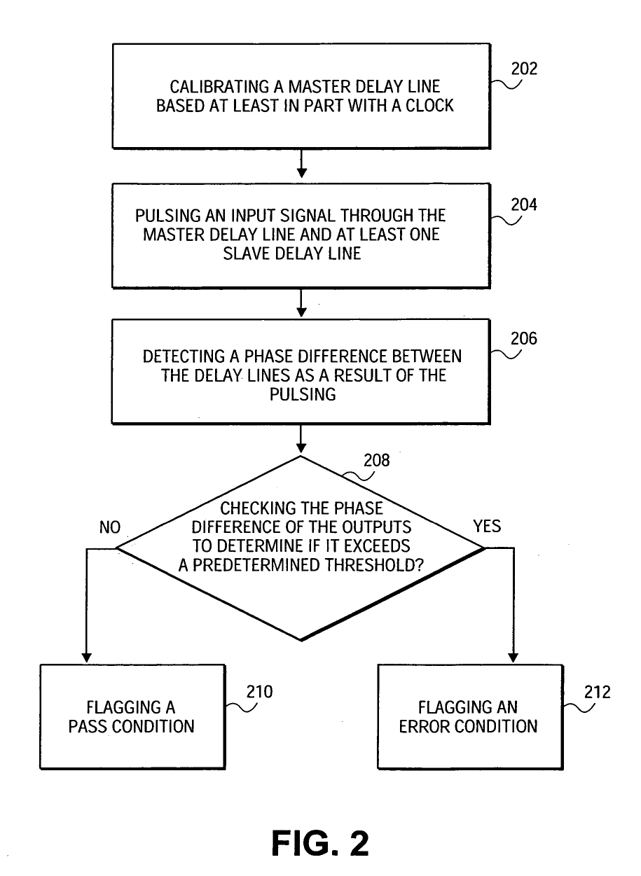

FIG. 2 is a flowchart illustrating a method in accordance with the claimed subject matter.

In one embodiment, the method depicts testing a device under test (DUT) that comprises a delay lock loop circuit. The DUT is either one of a(n): integrated device, system on a chip (SoC), memory controller, MCH, or a computing system, such as, a computer, personal digital assistant, and communication device.

The method comprises, but is not limited to, blocks 202, 204, 206, 210, 212, and a diamond 208. A calibration of a master delay line based at least in part on a clock, as illustrated in block 202, facilitates the testing by allowing the master delay line to serve as a master in a master and checker mode of operation. In one embodiment, the master and checker mode of operation refers to the master delay line being designated as a reference to insure proper functionality of the slave delay line or lines by verifying an absence of phase difference between the outputs of at least one slave delay line with respect to the output of the master delay line.

An input signal is pulsed through the master delay line and at least one slave delay line, as illustrated by block 204. One example of an input signal for pulsing the delay lines is a 266 Mhz base clock of a DDR DRAM. The detection for a phase difference between the outputs of the delay lines, as illustrated by block 206, may be performed by a plurality of phase detectors. In order to verify proper functionality of the delay lines, a comparison of the phase difference of the outputs of the delay lines to determine if it exceeds a predetermined threshold is performed, as illustrated in diamond 208. An error condition indicating the DUT has failed occurs if the phase difference exceeds the predetermined threshold, as illustrated in block 212. However, a pass condition indicating the DUT has passed, applies otherwise, as illustrated in block 210. In one embodiment, the predetermined threshold is the value of an individual delay cell. However, the claimed subject matter is not limited to this predetermined threshold value. For example, a variety of predetermined threshold values may be used, such as, a value of two delay cells or a fraction of a value of delay cell.

Although the claimed subject matter has been described with reference to specific embodiments, this description is not meant to be construed in a limiting sense. Various modifications of the disclosed embodiment, as well as alternative embodiments of the claimed subject matter, will become apparent to persons skilled in the art upon reference to the description of the claimed subject matter. It is contemplated, therefore, that such modifications can be made without departing from the spirit or scope of the claimed subject matter as defined in the appended claims.

1. An apparatus to test a delay lock loop circuit comprising:
a master delay line with a plurality of an individual delay cells;
at least one slave delay line, coupled to the master delay line, with a plurality of individual delay cells; and
the master delay line and at least one slave delay to receive a test pulse signal during a test mode of operation, and to generate a first delayed version of a test pulse signal and a second delayed version of a test pulse signal, respectively.

2. The apparatus of claim 1 further comprising at least one phase detector to compare a phase difference between the first delayed version of the test pulse signal and the second delayed version of the test pulse signal for at least one edge of the test pulse signal.

3. The apparatus of claim 1 wherein the apparatus comprises at least one of a memory controller, a memory controller hub, and a chipset.

4. The apparatus of claim 1 wherein at least one of the plurality of individual delay cells is programmable.

5. The apparatus of claim 2 wherein the apparatus is adapted to determine whether the phase difference meets or exceeds a predetermined threshold.

6. The apparatus of claim 5 wherein the predetermined threshold is substantially equivalent to a delay value of one of the individual delay cells.

7. The apparatus of claim 1 wherein the apparatus is coupled to a memory device.

8. The apparatus of claim 7 wherein the memory device is a DDR memory device.
